SEQUENCE LISTING (5 sequences)

SEQ ID NO: 1 - protein, 391 aa, Arabidopsis thaliana
MDVRESISLQNQVSMNLAKHVITTVSQNSNVIFSPASINVVLSIIAAGSAGATKDQILSFLKFSSTDQLNSFSSEIVSAVLADGSANGGPKLSVANGAWIDKSLSFKPSFKQLLEDSYKAASNQADFQSKAVEVIAEVNSWAEKETNGLITEVLPEGSADSMTKLIFANALYFKGTWNEKFDESLTQEGEFHLLDGNKVTAPFMTSKKKQYVSAYDGFKVLGLPYLQGQDKRQFSMYFYLPDANNGLSDLLDKIVSTPGFLDNHIPRRQVKVREFKIPKFKFSFGFDASNVLKGLGLTSPFSGEEGLTEMVESPEMGKNLCVSNIFHKACIEVNEEGTEAAAASAGVIKLRGLLMEEDEIDFVADHPFLLVVTENITGVVLFIGQVVDPLH

SEQ ID NO: 2 - protein, 392 aa, Brassica napus
MDVRESISLQNHVSLSLAKNVISTVSKNSNVIFSPASINVVLGIIAAGSTGETKDQILSFLNFPSIDQLNTFSSDIVSAVLADGSANGGPKLSAANAPWIDKSLSLQPSFKQLLDGSYKAASNLADFQTKAVEVIAEVNSWAEKETNGLITEVLPEGSADSMTRLIFANALYFKGTWNEKFDESLTKDGDFHLLDGSSKVTAPFMTSKKKQYVSAYDGFKVLGLPYLQGEDKRQFSMYLYLPDANNGLSDLLDKIVSTPGFLDSHIPRRQVKVGEFKIPKFKFSFGFEASDVLKGLGLASPFSGEDGLTEMVESPEMGKNLKVSSIFHKACIEVNEEGTEAAAASAGVIKLRGLAMEEEMIDFVADHPFLLVVMENITGVILFIGQVIDPLH

SEQ ID NO: 3 - protein, 4 aa, Artificial
  Reactive center loop
XXXR

SEQ ID NO: 4 - DNA, 17 bp, Artificial
  Forward primer
atggacgtgcgtgaatc

SEQ ID NO: 5 - DNA, 21 bp, Artificial
  Reverse primer
ttaatgcaacggatcaacaac

(19) United States
(12) Patent Application Publication
(10) Pub. No.: US 2010/0093619 A1
(43) Pub. Date: Apr. 15, 2010

(54) Insect Inhibition by Plant Serpin

(76) Inventors: Fernando Alvarez, Regensdorf (CH); Guy Smagghe, Temse (BE); Frank Van Breusegem, Brakel (BE); Steven Vandenabeele, Oudenaarde (BE); Dominique Vercammen, Bottelare (BE)

Correspondence Address: TRASKBRITT, P.C., P.O. BOX 2550, SALT LAKE CITY, UT, 84110, US

(21) Appl. No.: 12/312,019

(22) PCT Filed: Oct. 30, 2007
(86) PCT No.: PCT/EP2007/061667

§ 371 Date: Dec. 14, 2009

(30) Foreign Application Priority Data
Oct. 30, 2006 (EP) 06123189.0

(51) Int. Cl. A01N 37/00; A01P 7/04

(52) U.S. Cl. 514/12

(57) ABSTRACT

The present invention relates to a method to limit damage by insects and mites in plants, by the use of endogenous plant proteinase inhibitors. More specifically, it relates to the use of serpins comprising an arginine residue in their reactive center loop, like Arabidopsis thaliana serpin-1 to inhibit or limit insect and/or mite damage, such as the damage caused by insect and/or mite feeding.

The present invention relates to a method to limit damage by insect and mites in plants, by the use of endogenous plant proteinase inhibitors. More specifically, it relates to the use of serpins comprising an arginine residue in their reactive center loop, like Arabidopsis thaliana serpin-1 to inhibit or limit insect and/or mite damage, such as the damage caused by insect feeding. Insect pests are a serious problem in agriculture. They destroy millions of acres of staple crops such as corn, soybeans, peas, and cotton. Farmers must apply millions of liters of synthetic pesticides to combat these pests. However, synthetic pesticides pose many problems. They are expensive, force the emergence of insecticide-resistant pests, and they constitute a serious risk for the environment.

In order to develop a more economic and environmental pest control, biological approaches to pest control have been tried. In some cases, crop growers have introduced natural predators of the species sought to be controlled, such as non-native insects, fungi, and bacteria like Bacillus thuringiensis. Alternatively, crop growers have introduced large colonies of sterile insect pests in the hope that mating between the sterilized insects and fecund wild insects would decrease the insect population. However, none of these methods have been really successful.

As mentioned above, certain species of microorganisms of the genus Bacillus are known to possess pesticidal activity against a broad range of insect pests including Lepidoptera (Dulmage et al., 1981), Diptera (Goldberg and Margalit, 1977), Coleoptera (Krieg et al., 1987) and Hemiptera (Mathavan et al., 1987). Bacillus thuringiensis is probably the most successful biocontrol agents discovered to date. Pesticidal activity appears to be concentrated in parasporal crystalline protein inclusions, although insecticidal proteins have also been isolated from the vegetative growth stage of Bacillus. Several genes encoding these insecticidal proteins have been isolated and characterized. As a non limiting example, such genes have been disclosed in WO9116432, WO9421795 and U.S. Pat. No. 5,366,892.

Microbial pesticides, particularly those obtained from Bacillus strains, have played an important role in agriculture as alternatives to chemical pest control. Insecticidal proteins isolated from strains of Bacillus thuringiensis, known as 8-endotoxins or Cry toxins, are initially produced in an inactive protoxin form. These protoxins are proteolytically converted into an active toxin through the action of proteases in the insect gut.

Once activated, the Cry toxin binds with high affinity to receptors on epithelial cells in the insect gut, thereby creating leakage channels in the cell membrane, lysis of the insect gut, and subsequent insect death through starvation and septicemia.

During recent years, agricultural scientists have developed crop plants with enhanced insect resistance by genetically engineering crop plants to produce insecticidal proteins from Bacillus. Such plants have been disclosed in, amongst others, WO9116432 and WO9421795. However, these Bt insecticidal proteins only protect plants from a relatively narrow range of pests. Furthermore, field durability is predicted to be limited by the development of resistance to Bt toxins in pest populations (Tabashnik et al 2000). Thus, there is an immediate need for methods that enhance the effects of insecticidal proteins.

One possibility to enhance the insect resistance is the co-expression of the Bt insecticidal proteins with another polypeptide having insecticidal activity, as disclosed in WO2005083095. Alternatively, the application of other broad spectrum insect inhibitory polypeptides, such as proteinase inhibitors has been studied. An overview of proteinase inhibitor genes used in combat against insects, pest and pathogens is given by Haq et al., (2004). However, the pH dependency and specificity of the proteinase inhibitor is extremely important and not all proteinases inhibitors are successful. In some cases, the transgenic plants overexpressing the proteinase inhibitor caused a growth stimulation of the larvae (Girard et al., 1998), although the inhibitor used was capable of inhibiting the digestive proteases of the larvae. This indicates that a selection of a proteinase inhibitor purely on in vitro characteristics is very difficult, if not impossible.

Within the group of proteinase inhibitors, plant proteinase inhibitors and within this group, serpins have drawn some interest as possible pest inhibitors. Plant serpins have been studied intensively over the past years. In cereals, serpins are collectively called Z proteins, and constitute 5% of the total albumin in grains (Hejgaard, 1982). Several serpins from wheat, barley, rye, and oat have been identified and characterized (Rasmussen, 1993; Østergaard et al., 2000; Brandt et al., 1990; Lungaard and Svensson, 1989; Rosenkrands et al. 1994; Rasmussen et al., 1996a; Dahl et al., 1996; Hejgaard, 2001; Hejgaard and Hauge, 2002) Biochemical studies with plant serpins from cereals have demonstrated their inhibitory action against different animal proteases such as trypsin, chymotrypsin, cathepsin G, and elastase (Østergaard et al., 2000; Dahl et al., 1996; Hejgaard, 2001; Hejgaard and Hauge, 2002). Also the serpin isolated from squash phloem was reported to be an elastase inhibitor (Yoo et al., 2000)

Whereas in animals, serpins are known to be involved in fundamental biological processes (Patston, 2000; van Gent et al., 2003) no precise role has yet been assigned to plant serpins. The high abundance of serpins in cereal seeds has led to the hypothesis that they could be involved in defense of storage tissue against insect feeding (Østergaard et al., 2000; Hejgaard and Hauge, 2002). Although direct feeding of aphids with CmPS-1 did not affect their survival, the negative correlation between the survival of aphids feeding on squash leaves and expression levels of the phloem serpin CmPS-1 supports the defense theory (Yoo et al., 2000) Gene expression studies in barley have revealed that serpin transcripts are present in developing grain, but also in vegetative tissues, such as roots, shoots, and leaves. Serpin protein could be detected in phloem cells, meristem, and root cap cells of the young root, and in root cap, coleorhiza, and apical meristem of embryonic roots. Also in young leaves some phloem cells produced serpin proteins (Roberts et al., 2003). Although these expression patterns are intriguing, complete insight into the precise functional role of plant serpins is still lacking.

Based on this possible protection, several serpins have been tested as insect inhibitors, but none of those have been extremely effective. WO9413810 discloses the use of a Nicotania alata type II serine proteinase inhibitor precursor with at least four domains for increasing plant resistance to pest, but the effect is limited to a retardation in growth of the nymphs tested. US2003/0018990 discloses the use of a serine proteinase of Brassica oleracea for obtaining resistance to herbivorous insects. Depending upon the parameters measured, and the insects used, the results obtained are comparable or less efficient than the results obtained with Bt. Yoo et al. (2000) described the use of Cucurbita maxima phloem serpin-1 for inhibiting the piercing-sucking aphid Myzus persicae. Although they claim to see a decrease in survival on the transgenic plants in function of the time, they could not demonstrate any toxicity when using the phloem and the effects of survival on the transgenic plants might be due to other factors.

Surprisingly we found that AtSerpin1 can result in a complete inhibition of pupal development of Spodoptera littoralis, indicating a very effective insecticidal capacity. AtSerpin1 is a homolog of, amongst others, BSZx, BSZ7, and WSZ2b and belongs to a class of serpin with arginine at the P1 position in the reactive center loop that never has been tested as insect inhibitor in plants. It strongly differs in sequence from the serpins described in WO9413810 and US2003/0018990. Although it shows a limited homology with Cucurbita maxima phloem serpin-1, it mainly differs from this serpin by the arginine in the P1 position of the reactive centre loop (RCL). This arginine residue would largely determine the specificity of the inhibitor. Indeed, Vercammen et al. (2006) showed that AtSerpin1 strongly inhibits the metacaspase AtMC9 from Arabidopsis, which is a cysteine protease. Using recombinant AtSerpin1, the authors also demonstrated inhibition of AtMC4 in vitro which was previously shown to be Arg-specific (Vercammen et al., 2004). Moreover, Yoo et al.,(2000), also claimed the importance of the P1 arginine in the specificity of the related BSZx.

A first aspect of the invention is the use of a recombinant serpin, comprising a reactive center loop with a leucine/arginine or aspartic acid/arginine sequence, for limiting insect and/or mite provoked damage in plants. Preferably, said serpin comprises a reactive center loop comprising the sequence [I/V]×[L/D]R, whereby X can be any amino acid. Even more preferably, the arginine is situated in position P1 of the RCL; P1 is the position in the RCL after which the target proteinase is cleaving the proteinase inhibitor, causing a rearrangement of the serpin by which the proteinase is trapped and inactivated. Preferably, said serpin belongs to the inhibitor family IA, as determined by MEROPS (http://merops.sanger.ac.uk), showing sequence homology to human alpha1-antitrypsin. Preferably said serpin is selected of the group consisting of Arabidopsis thaliana serpin At1g47710, Barley serpin BSZx (Rasmussen, 1993), Barley serpin BSZ7 (Rasmussen et al., 1996b), Wheat serpin WSZ2b (Ostergaard et al., 2000), Cucumis sativus serpin gi|58416137, Oryza sativa serpin gi|37700305, Citrus×paradise serpin gi|26224736, Solanum tuberosum serpin gi|62950609, Lycopersicon esculentum serpin gi|14685955, Nicotiana tabacum serpin gi|52837819, Brassica rapa serpin gi|54416864, Vitis vinifera serpin gi|33401535, Antirrhinus majus serpin gi|51113970, Triphysaria versicolor serpin gi|68033793, Helianthus paradoxus serpin gi|33123072, Gossypium arboretum serpin gi|13245345, Populus nigra serpin gi|60218046 and Brassica napus (SEQ ID No 2). Even more preferably, said serpin has a RCL sequence comprising IKLR. In one preferred embodiment, said serpin comprises SEQ ID No 1 (At1g47710). In another preferred embodiment, said serpin comprises SEQ ID No 2 (Brassica napus) Preferably, said insect caused damage is caused by a chewing insect or mite. More preferably, said insect or mite belongs to an order selected from the group consisting of the orders Lepidoptera, Coleoptera, Homoptera and Acari. Even more preferably, said insect or mite is selected from the group consisting of Spodoptera spp, Sesamia spp., Ostrinia spp., Leptinotarsa spp., Tribolium spp., Acyrthosiphon spp., Bemisia spp. and Tetranychus spp. Most preferably said insects or mites belong to the species Spodoptera littoralis, Sesamia nonagroides, Ostrinia nubilalis, Leptinotarsa decemlineata, Tribolium castaneum, Acyrthosiphon pisum, Bemisia tabaci and/or Tetranychus urticae.

A preferred embodiment is the use of said serpin, whereby said serpin is applied by spraying. Another preferred embodiment is the use of said serpin, whereby said serpin is overexpressed in a plant. In case of overexpressing, the concentration in the plant material is preferably at least 0.65 mg/kg wet weight, even more preferably at least 6.5 mg/kg wet weight, most preferably at least 65 mg/kg wet weight.

Another aspect of the invention is the use of a transgenic plant, expressing a recombinant serpin, comprising a reactive center loop with a leucine/arginine or aspartic acid/arginine sequence, for limiting insect and/or mite provoked damage in plants. Preferably, said serpin has a RCL comprising the sequence IKLR. Even more preferably, said serpin comprises SEQ ID No 1 (At1g47710)

### BRIEF DESCRIPTION OF THE FIGURES

FIG. 1: Larval feeding inhibition in Spodoptera littoralis, on feed mixed with AtSerpin1 at a concentration of 0.65 mg, 6.5 mg and 65 mg per kg wet weight of feed.

FIG. 2: weight reduction of Spodoptera littoralis after 5 days treatment, for a concentration of 65 mg AtSerpin1/kg feed.

FIG. 3: Pupal weight inhibition in Spodoptera littoralis on feed mixed with AtSerpin1 at a concentration of 0.65 mg, 6.5 mg and 65 mg per kg wet weight of feed, as measured after 14 days of treatment.

FIG. 4: Pupal development weight inhibition in Spodoptera littoralis on feed mixed with AtSerpin1 at a concentration of 0.65 mg, 6.5 mg and 65 mg per kg wet weight of feed, as measured after 14 days of treatment.

FIG. 5: Reduction of weight and inhibition of pupal development in Spodoptera littoralis, after 14 days of treatment, for a concentration of AtSerpin 1 of 65 mg/kg feed.

FIG. 6: Reduction of weight and inhibition of pupal development in Spodoptera littoralis, after 14 days of treatment, for a concentration of AtSerpin 1 of 6.5 mg/kg feed.

FIG. 7: Reduction of weight and inhibition of pupal development in Spodoptera littoralis, after 14 days of treatment, for a concentration of AtSerpin 1 of 0.65 mg/kg feed.

FIG. 8: The effect on increase in fresh weight (mg) of larvae and pupae of S. littoralis after feeding on artificial diet containing AtSerpin1 (65 pg/g) as compared to artificial diet without the protease inhibitor (control). The feeding assays were started with third-instar larvae with an average fresh weight of 8-10 mg. Data are expressed as means±SE (n=64). In all three cases, the treatment with AtSerpin1 caused a significant reduction in weight as compared to the untreated control groups (Student t-test, p<0.05).

FIG. 9: Effect on S. littoralis larval serine-like proteases after feeding during 6 days on artificial diet containing AtSerpin1 at 65 μg/g. Data are expressed as means±SE (n=24). Different letters between bars indicate significant differences between treatments (Student t-test, p<0.05).

FIG. 10: Inhibition of serine-like protease activities from S. littoralis extracts by AtSerpin1 (WT). Data are the mean±SE of duplicate measurements from a unique pool of gut extracts.

FIG. 11: Inhibition of serine-like protease activities from S. nonagrioides extracts by AtSerpin1 (WT). Data are the mean±SE of duplicate measurements from a unique pool of gut extracts.

FIG. 12: Inhibition of cysteine-like protease activities from L. decemlineata extracts by AtSerpin 1 (WT). Data are the mean±SE of duplicate measurements from a unique pool of gut extracts.

FIG. 13: Inhibition of cysteine-like protease activities from T. castaneum extracts by AtSerpin1 (WT). Data are the mean±SE of duplicate measurements from a unique pool of gut extracts.

FIG. 14: Inhibition of cysteine-like protease activities from A. pisum extracts by AtSerpin1 (WT). Data are the mean±SE of duplicate measurements from a unique pool of gut extracts.

FIG. 15: Inhibition of cysteine-like cathepsin-L protease activities from B. tabaci extracts by AtSerpin1 (WT). Data are the mean±SE of duplicate measurements from a unique pool of gut extracts.

FIG. 16: Inhibition of cysteine-like protease activities from T. urticae extracts by AtSerpin1 (WT). Data are the mean±SE of duplicate measurements from a unique pool of gut extracts.

FIG. 17: Western blot showing the presence of AtSerpin1 in leaf tissue of transgenic A. thaliana. Col-0, non transformed (control); 205, 308 and 401 transgenic A. thaliana.

FIG. 18: Growth of S. littoralis larvae feeding on different lines of transgenic A. thaliana plants, expressing AtSerpin1 (lines 205, 308 and 401) or on its corresponding non-transformed isogenic plants (Col-0). Feeding assays were performed with second-instar larvae for three days. Larval growth is expressed in mg of fresh weight. Data are the mean±SE (n=20). Different letters mean significant differences between treatments (ANOVA, Fischer test: p<0.05).

FIG. 19: Response of S. littoralis larval serine proteases after feeding for 3 days on either control or transgenic line 401 A. thaliana plants. Protease activities were compared using the U-Mann Whitney test. Data are the mean±SE (n=20). Different letters between columns mean significant differences between treatments (Student t-test, p<0.05).

### EXAMPLES

### Materials and Methods to the Examples

### Recombinant Atserpin1 Production

Recombinant Atserpin1 production and purification was done as described in Vercammen et al., 2006.

The cDNA for the ORF of At1g47710 was obtained by RT-PCR with the following forward and reverse primers, provided with the adequate 5′ extensions for Gateway™ cloning (Invitrogen): 5′-ATGGACGTGCGTGAATC-3′ and 5′-TTAATGCAACGGATCAACAAC-3′. After recombination in pDEST17, the plasmid was introduced into E. coli strain BL21(DE3)pLysE and production of the HIS6-tagged protein induced by incubation in 0.2 mM isopropyl-β-D-thiogalactopyranoside for 24 h. The protein was purified by metal ion affinity chromatography (TALON™; BD, Franklin Lakes, N.J.). Protein concentration and purity were checked by Bradford analysis (BioRAD) and SDS-polyacrylamide gel electrophoresis (PAGE)

### Generation of Plants Overproducing AtSerpin1

The cDNA for the ORF of At1g47710 was obtained by reverse transcription-PCR with the following forward and reverse primers, provided with the adequate 5′ extensions for Gateway™ cloning (Invitrogen): 5′-ATGGACGTGCGTGAATC-3′ and 5′-TTAATGCAACGGATCAACAAC-3′. The ORF was cloned into the binary vector pB7GW2 (Karimi et al., 2002) via Gateway™ recombination (Invitrogen, Carlsbad, Calif.). In the resulting vector, the ORF is under transcriptional control of the promoter of the cauliflower mosaic virus 35S (CaMV 35S); the glufosinate ammonium resistance gene was present to allow for transgene selection. Binary constructs were transformed into Agrobacterium tumefaciens strain C58C1RifR[pMP90] and transgenic Arabidopsis thaliana (L) Heyhn. Columbia-0 were obtained via floral dip transformation (Clough and Bent, 1998) and subsequent selection. Single-locus homozygous lines with proficient transgene expression were selected for further analysis.

### Antisera

For the production of two antisera, SB1243 and SB1244, three times 200 μg of purified recombinant AtSerpin1 were used as immunogen per rabbit (Eurogentec, Seraing, Belgium). The antisera were selected on the base of lack of immunoreactivity of pre-immune sera against Arabidopsis extracts. The dilution used in immunodetection was 1/20000

### Insects and Mites

A selection of economically important pest insects and mites was made to support the insecticide potency and wide target pest range of AtSerpins. The selected Lepidoptera (caterpillars) and Coleoptera (beetles) are representative pest insects with biting-chewing mouth paths and important in agriculture, horticulture, forestry and stored products. The selected Homoptera (aphids, whiteflies) and Acari (mites) are good representatives for piercing-sucking pests, being very important in agriculture, horticulture, forestry.

### Lepidoptera:

A colony of the cotton leafworm Spodoptera littoralis (CLW) (Lepidoptera: Noctuidae) was reared on a semi-artificial diet at standard conditions in the laboratory. Larvae were collected and frozen at −20° C. until analysis.

For the artificial feeding tests, newly moulted (0-6h) 3rd instar larvae of the cotton leafworm Spodoptera littoralis (Lepidoptera: Noctuidae) were selected from a continuous stock colony in the Laboratory of Agrozoology at Ghent University, Belgium, that was kept at standard conditions of 23±2° C.; 65±5% relative humidity and a 16:8 (light:dark) regime (Smagghe et al., 2002).

The cotton leafworm is a polyphagous noctuid species of world economic importance in agriculture and horticulture. Such caterpillars cause high levels of damage in at least 87 crop species belonging to 40 families distributed all over the world. Also many populations developed high levels of resistance towards most insecticide groups (Alford, 2000).

Larvae of Mediterranean corn borer, Sesamia nonagroides (MCB) (Lepidoptera: Noctuidae), were frozen and stored at −20° C. until needed.

Larvae of European corn borer, Ostrinia nubilalis (Lepidoptera: Crambidae) (ECB), were collected and frozen at −20° C. until analysis.

### Coleoptera:

Colorado potato beetles Leptinotarsa decemlineata (CPB) (Coleoptera: Chrysomelidae) were reared on freshly-cut potato foliage, Solanum tuberosum, collected and frozen at −20° C. until analysis.

Adults of the red flour beetle, Tribolium castaneum (Coleoptera: Tenebrionidae) were selected from a colony maintained in the laboratory at standard conditions, frozen and stored at −20° C. until needed.

### Homoptera:

A laboratory colony of the pea aphid Acyrthosiphon pisum (PA) (Homoptera: Aphididae) was reared on pea plants, Vicia faba. Adults were selected, frozen en stored at −20° C. until needed. Adults of the sweetpotato whitefly, Bemisia tabaci (Homoptera: Aleyrodidae) were selected, frozen and stored at −20° C. until needed.

### Acari:

Spider mites, Tetranychus urticae (Acari: Tetranychidae) were selected from a colony maintained in the laboratory at standard conditions, frozen en stored at −20° C. until needed.

### Insect Bioassay on Artificial Diet

Third instar S. littoralis larvae weighting 8-10 mg each were starved for 4 h before the start of the bioassay. Four larvae were placed per Petri dish (9 cm diameter) and fed ad libitum with artificial diet containing AtSerpin1 at a concentration of 65 μg/g, or on artificial diet without the protease inhibitor (control). Larvae were weighed on day 2, 4 and 6. Larvae were fed until adult emergence or for six days, then some of them were dissected and each midgut homogenized in 500 μl of 0.15 M NaCl. Midgut extracts were centrifuged and the supernatants individually frozen for enzymatic determinations The bioassay was carried out in environmental chambers at 25±2° C., 65±5% relative humidity and a 16:8 h (L:D) photoperiod with 124 larvae per treatment

Larvae of S. littoralis were used to analyze the effects of serpin-1 on their growth. Larvae were placed in a test age Petri dish together with about 10 g of artificial food based on ‘Manduca Heliothis Premix’ (Stonefly Industries, Bryan, Tex., USA). Ten larvae were tested for each concentration. During the experiment, fresh food was provided ad libitum. Serpin-1 was added to the artificial diet at a range of 3 different concentrations (0.65, 6.5 and 65 mg/kg). In controls, larvae were fed with untreated artificial diet. In treatments and controls, fresh individual larval weights were scored at 2-3 day intervals for a period of 1 week and used as insecticidal endpoints of inhibition of insect growth (Rabea et al., 2005).

For each treatment and the control, data are expressed as means±SD based on 10 measurements. A student's t-test was employed to detect significant differences between treatments and the control insects.

Inhibitory Activity of Arabidopsis thaliana Serpins

Complete guts from CLW, MCB, ECB and CPB larvae were dissected and subsequently homogenized in 0.15 M NaCl, centrifuged at 10,000 g for 5 min, and the supernatants pooled and stored frozen (−20° C.). For PA, whole insect bodies were used.

Inhibitory activity of Serpin1 from Arabidopsis thaliana was tested in vitro against serine-like protease activities from CLW, MCB (trypsin and chymotrypsin) and ECB (trypsin and elastase), and against cysteine-like protease activities (cathepsin-B and cathepsin-L) from PA and CPB. A. thaliana serpins were preincubated at room temperature with the gut extracts for 15 min, prior to addition of substrate. Serpin concentrations varied from 0.02-20 μM. Standard fluorometric substrates used were Z-Arg-Arg-amc, Z-Phe-Arg-amc, and N-Suc-Leu-Leu-Val-Tyr-4-Methylcoumaryl-7-amide, from Bachem. For measuring elastase activity the colorimetric substrate Sa2PppNa (N-succinyl-(alanine)₂-prolinephenylalanin-p-nitroanilide) were used, from Sigma. All assays were carried out in duplicate with pooled gut extracts. Fluorescence was monitored for 30 min at λex of 380 nm and λem of 460 nm in a microtiterplate reader. For measuring the elastase activity in ECB, the colorimetric substrate Sa2PppNa (N-succinyl-(alanine)₂-proline-phenylalanin-p-nitroanilide) were used, from Sigma.

Absorbance was measured at 410 nm for elastase activity in a microplate reader. Insect protease activities were determined at 30° C., at pH 10.5 for CLW, MCB and ECB, and at pH 7.5 for PA and CPB, in 100 μl of reaction mixture.

### Bioassay on Transgenic Plants Expressing AtSerpin1

Second instar S. littoralis larvae were starved for 4 hours before infesting A. thaliana plants expressing AtSerpin1 or on its corresponding nontransformed isogenic plants. Four larvae were confined per pot using a fine mesh. Larvae were allowed to eat for 3 days and, at the end of this period, all larvae were weighed and dissected for midgut protease assays as described above. Six pots plants per genotype were used, which were held in a growth chamber at 25±1° C., 65±5% relative humidity and a 16:8 h (L:D) photoperiod.

### Example 1

### Larval Feeding Inhibition and Inhibition of Pupal Development in Spodoptera littoralis Fed on a Diet Comprising AtSerpin1

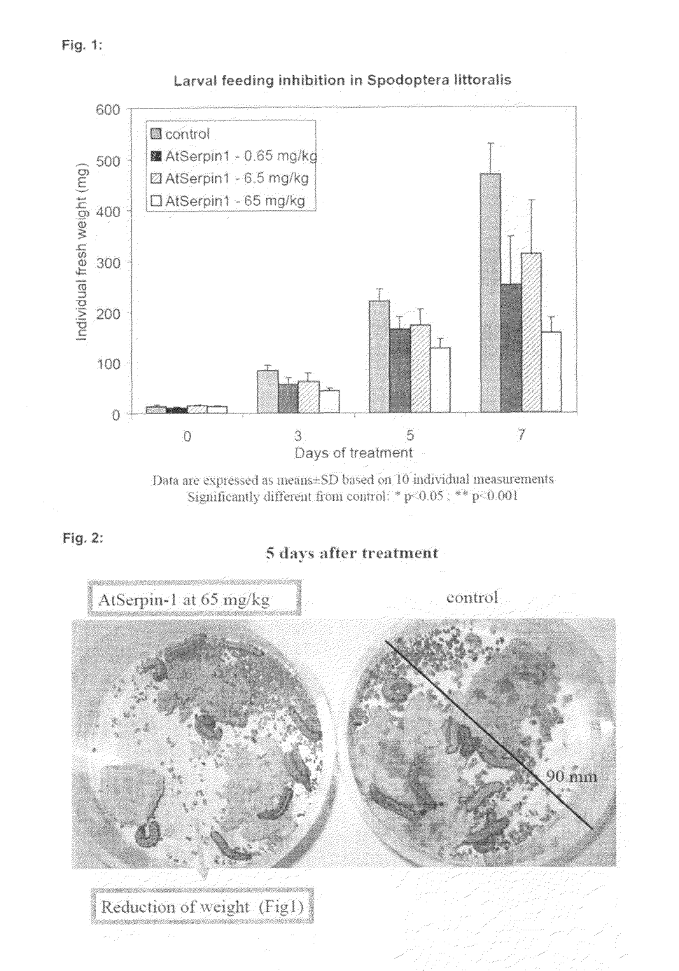

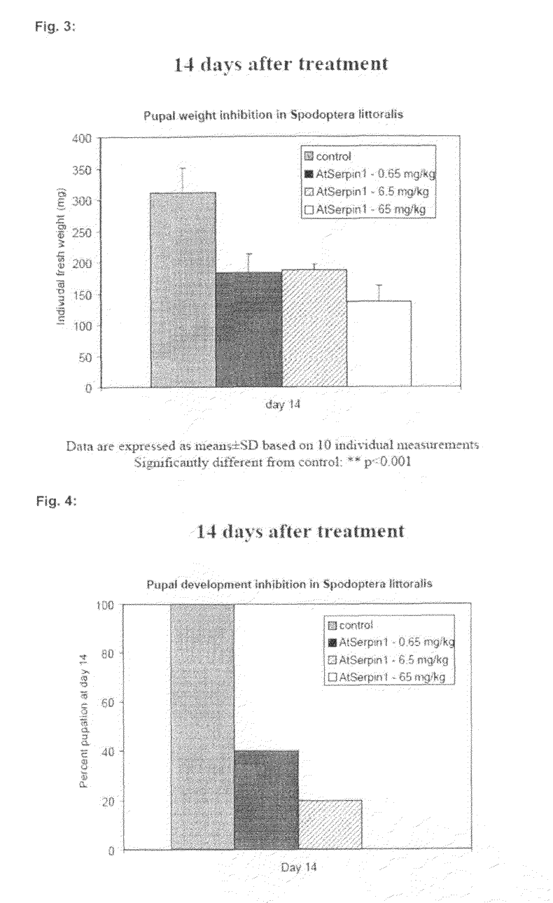

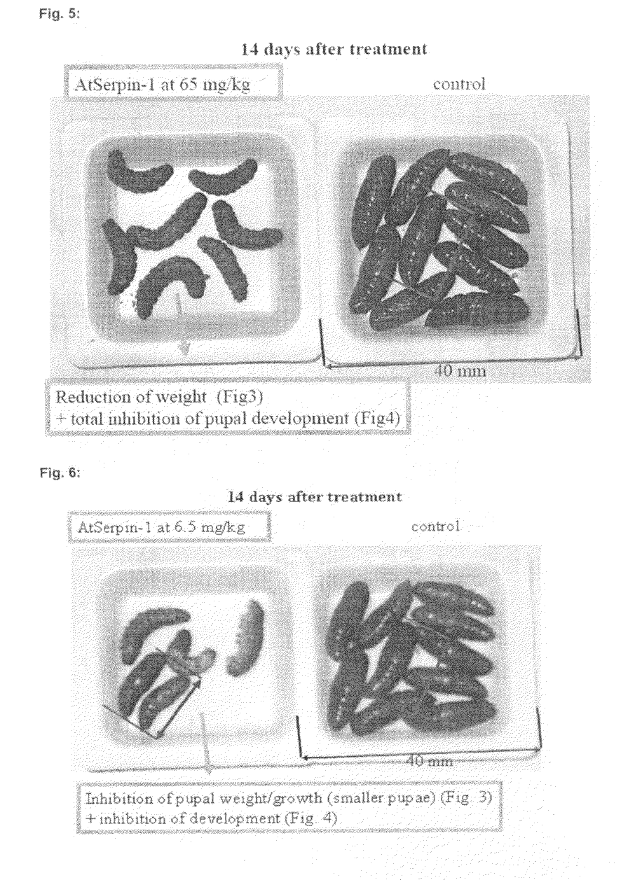

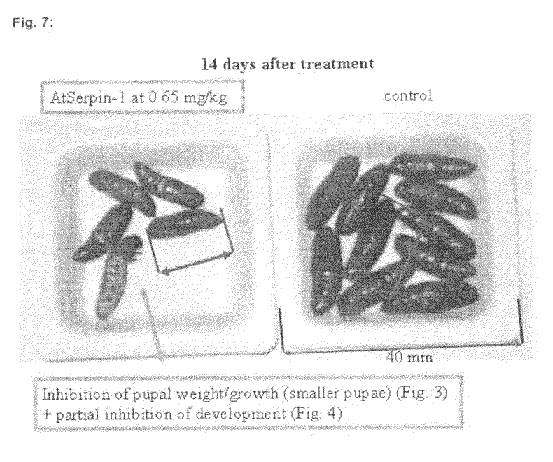

Inhibition of growth and pupal development was measured on an artificial control diet, and a diet comprising 0.65, 6.5 or 65 mg recombinant AtSerpin1/kg feed. A significant inhibition of weight increase of the larvae can be seen from day three, for all concentrations, and the effect becomes more pronounced with the time, for all concentrations. All concentrations resulted in a significant inhibition of pupal development, starting from 60% inhibition of the lowest concentration up to 100% inhibition for 65 mg AtSerpin1/kg feed. Compared with Bt, the inhibition of pupal development is far more pronounced, even at the lowest concentration, indication that AtSerpin1 is a very effective inhibitor of Spodoptera littoralis. (FIG. 1-7)

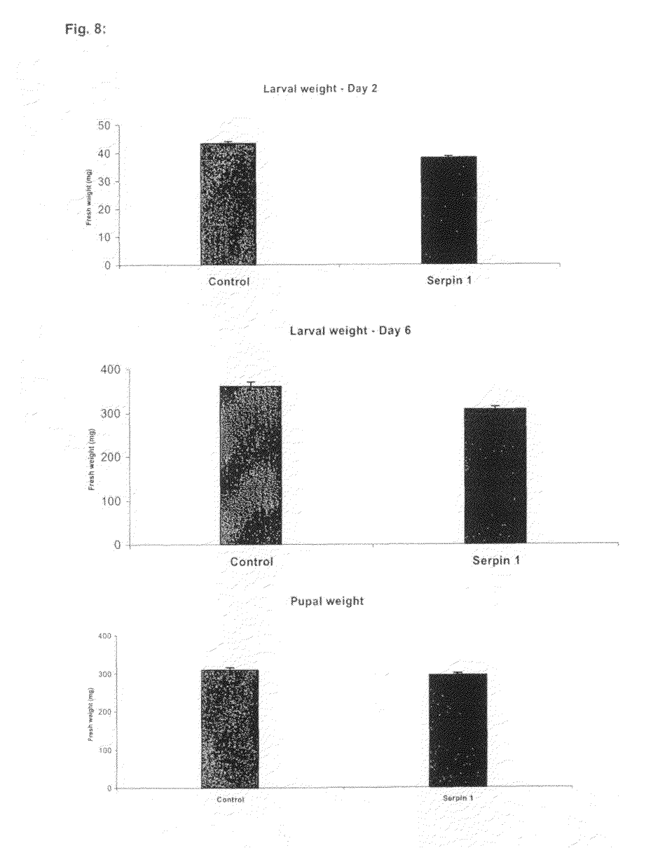

The experiment was repeated and the results confirmed the earlier insecticide effects of AtSerpin1 inhibiting the larval growth in the cotton leafworm S. littoralis (FIG. 8). A significant insecticide effect was already visible in the first 2 days of feeding. The weight of larvae fed on diet containing AtSerpin1 at 65 μg/g, was significantly reduced as compared to untreated diet. Interestingly, the effect retained as the decrease in weight remained significant over time. Further, pupal biomass of was also significantly decreased (FIG. 8).

In addition, the treatment with AtSerpin1 reduced significantly the survival of adults to 75.9% (Chi-square, p<0.05) as compared to 92.3% in the untreated control groups.

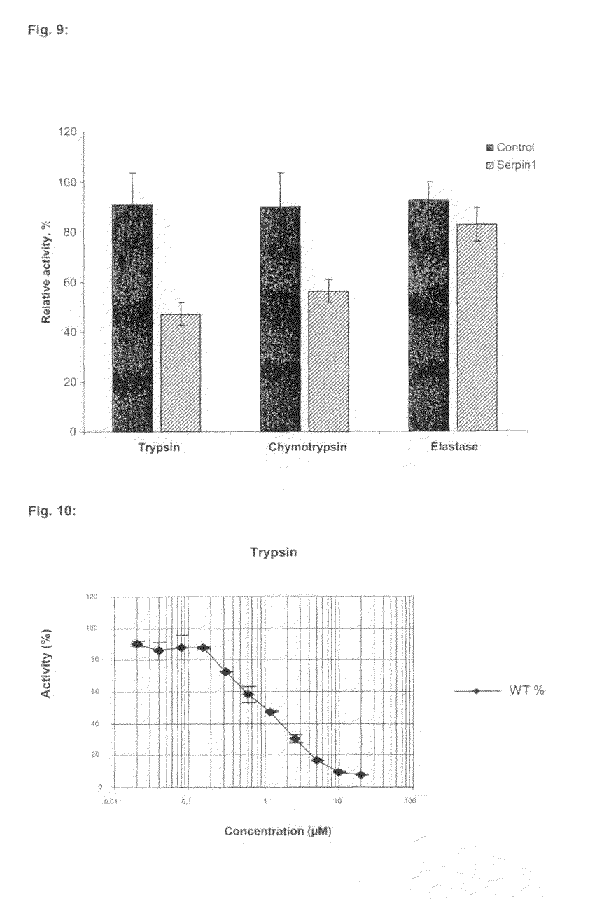

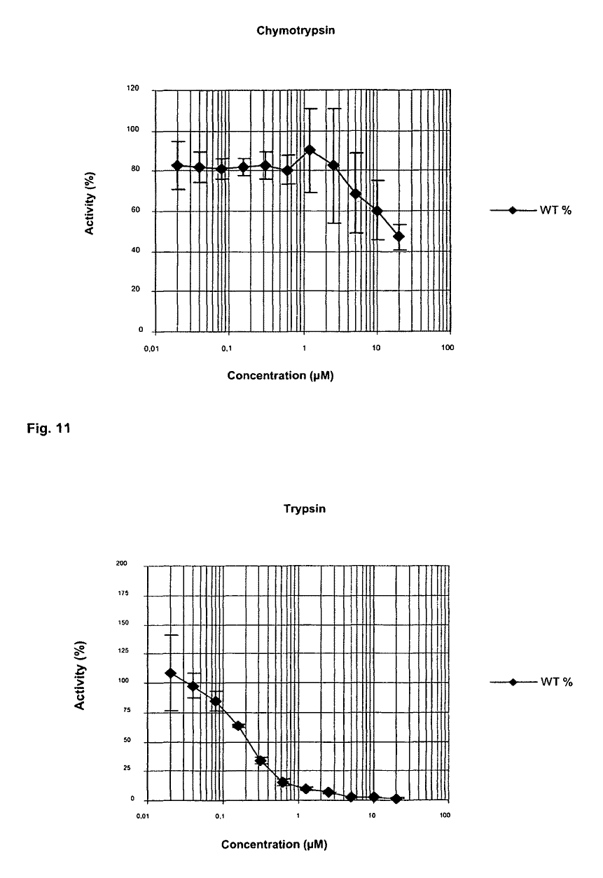

The effect of the artificial feeding on the activity of the larval serine proteases was measured, and especially for trypsin a significant decrease in relative activity was detected (FIG. 9)

### Example 2

### Inhibition of Enzymes of the Cotton Leafworm, Spodoptera littoralis (Lepidoptera: Noctuidae)

As shown in FIG. 10, AtSerpin1 exerts a clear inhibition of serine-like trypsin activities already at low concentration with 50% inhibition at about 1 μM concentrations. Maximal inhibition of trypsin activity was scored with ≧10 μM. For chymotrypsin activity inhibition the concentration of AtSerpin1 needed to inhibit 50% was estimated at 10-20 μM (FIG. 10).

With the use of colorimetric substrates, table 1 confirms the high potency of AtSerpin1 to inhibit trypsin protease activities from S. littoralis extracts. The tests for inhibition of chymotrypsin activities with AtSerpin1 showed limited activity with 40-56% inhibition with the highest concentration tested (10 μM).

TABLE 1
Inhibition of serine-like protease activities from
S. littoralis extracts by the AtSerpin1.

| | % Inhibition | | | | | |
|---|---|---|---|---|---|---|
| | Trypsin | | | Chymotrypsin | | |
| | 1.25 μM | 5 μM | 10 μM | 1.25 μM | 5 μM | 10 μM |
| AtSerpin1 | 52 ± 1 | 83 ± 1 | 90 ± 1 | 10 ± 21 | 31 ± 20 | 40 ± 15 |

### Example 3

### Inhibition of the Enzymes of the Mediterranean Corn Borer, Sesamia nonagrioides (Lepidoptera: Noctuidae)

FIG. 11 demonstrates a very strong inhibition by AtSerpin1 of trypsin activities already at low concentration with 50% inhibition at about 0.1 μM concentrations. Maximal inhibition of trypsin activity was scored already with 0.5-1 μM. For chymotrypsin activity inhibition the concentration of AtSerpin1 needed to inhibit ≧50% was estimated at ≧10 μM. Table 2 clearly provides confirmation of the high potency of AtSerpin1 to inhibit trypsin protease activities from S. nonagrioides extracts. The tests for inhibition of chymotrypsin activities with AtSerpin1 showed no activity

TABLE 2
Inhibition of serine-like protease activities from
S. nonagrioides extracts by the AtSerpin1.

| | % Inhibition | | | | | |
|---|---|---|---|---|---|---|
| | Trypsin | | | Chymotrypsin | | |
| | 1.25 μM | 5 μM | 10 μM | 1.25 μM | 5 μM | 10 μM |
| AtSerpin1 | 90 ± 1 | 97 ± 1 | 98 ± 1 | ni | ni | ni |

ni = no inhibition

### Example 4

### Inhibition of the Enzymes of the European Corn Borer, Ostrinia nubilalis (Lepidoptera: Crambidae)

With use of colorimetric substrates for trypsin and chymotrypsin activities, AtSerpin1 shows limited potency to inhibit trypsin protease activities from O. nubilalis extracts with 28% at 2 μM (Table 3). The tests for inhibition of chymotrypsin activities with AtSerpin1 showed no activity.

TABLE 3
Inhibition of serine-like protease activities from
O. nubilalis extracts by AtSerpin1.

| | % Inhibition | |
|---|---|---|
| | Trypsin | Elastase |
| | 2 μM | 2 μM |
| AtSerpin1 | 28 ± 2 | ni |

ni = no inhibition

### Example 5

### Inhibition of the Enzymes of the Colorado Potato Beetle, Leptinotarsa decemlineata (Coleoptera: Chrysomelidae)

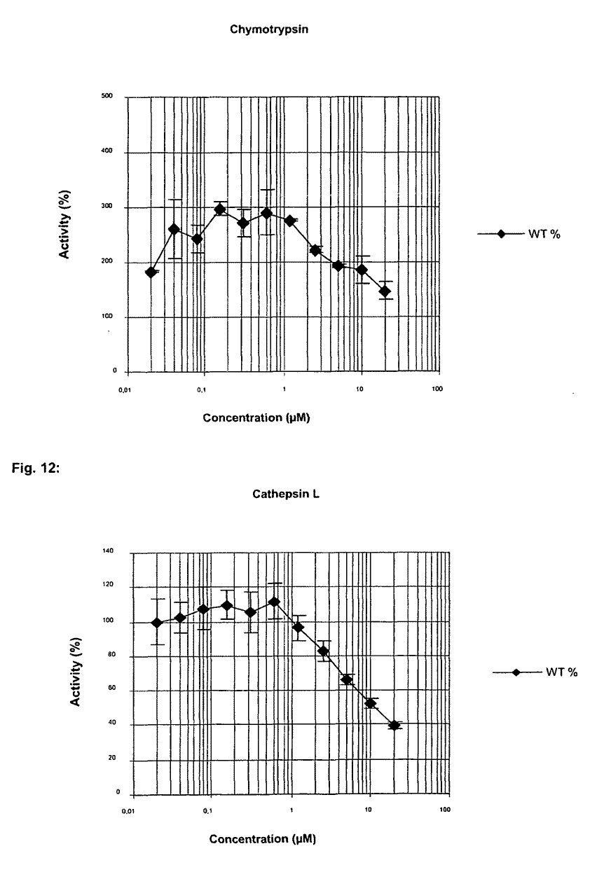

As shown in FIG. 12 with use of fluorometric substrates, AtSerpin1 provokes 50% inhibition of cysteine-like cathepsin-L protease activities at ≧10 μM in the Colorado potato beetle gut extracts.

For the cathepsin-B activity inhibition, the concentration of AtSerpin1 needed to inhibit 50% was estimated >10 μM. With use of colorimetric substrates, AtSerpin1 inhibits cathepsin-B protease activities with 40% already at relatively low concentrations of 1.25 μM (Table 4). For cathepsin-L activities the potency of AtSerpin1 for inhibition was lower, yielding 4% at 1.25 and increasing up to 48% at 10 μM.

TABLE 4
Inhibition of cysteine-like protease activities from
L. decemlineata extracts by the AtSerpin1.

| | % Inhibition | | | | | |
|---|---|---|---|---|---|---|
| | Cathepsin B | | | Cathepsin L | | |
| | 1.25 μM | 5 μM | 10 μM | 1.25 μM | 5 μM | 10 μM |
| AtSerpin1 | 40 ± 8 | 47 ± 8 | 46 ± 11 | 4 ± 10 | 34 ± 4 | 48 ± 4 |

### Example 6

### Inhibition of the Enzymes of the Red Flour Beetle, Tribolium castaneum (Coleoptera: Tenebrionidae)

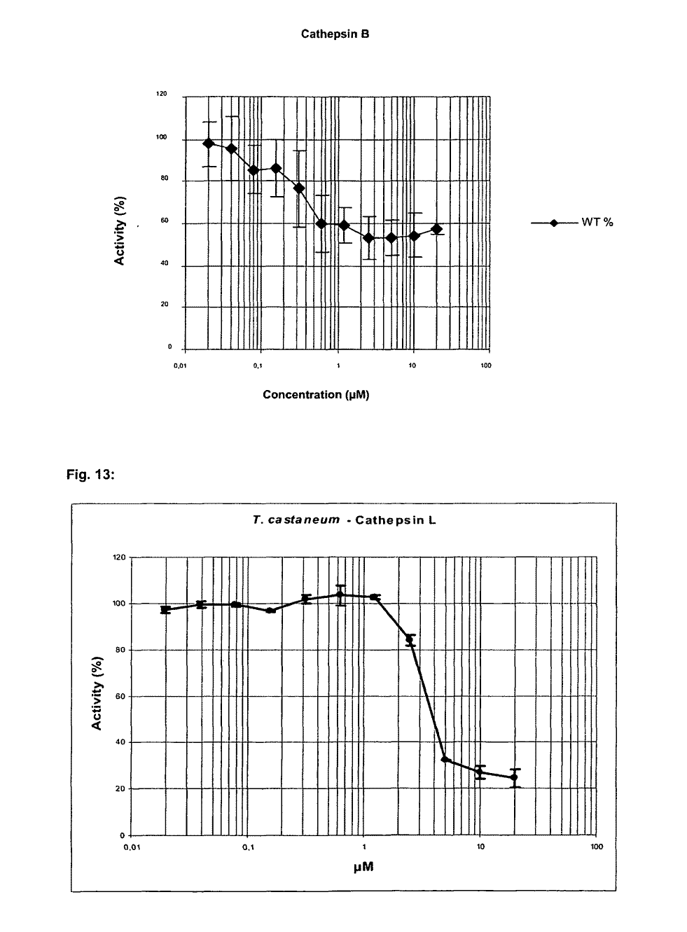

FIG. 13 shows that the cysteine-like cathepsin-L activity is inhibited by the AtSerpin1 with an IC50=4 μM.

### Example 7

### Inhibition of the Enzymes of the Pea Aphid, Acyrthosiphon pisum (Homoptera: Aphididae)

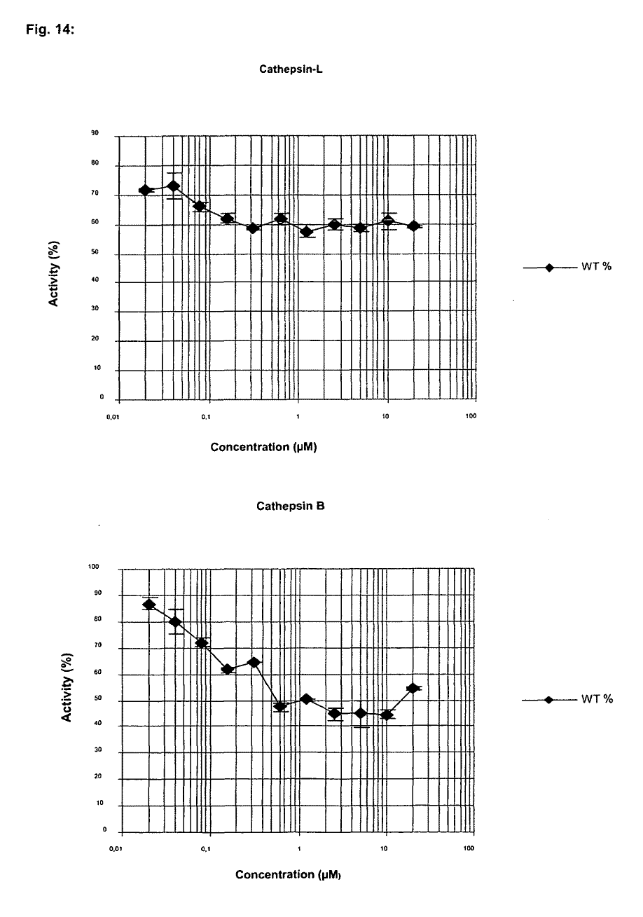

As shown in FIG. 14, AtSerpin1 exerts inhibition of cysteine-like cathepsin-L protease activities. However, it was strange in this experiment that the effect with AtSerpin1 flattened around 60% inhibition. For the cysteine-like cathepsin-B activity inhibition of aphid A. pisum extracts the concentration of AtSerpin1 needed to inhibit 50% was estimated at around 1 μM (FIG. 14).

With use of colorimetric substrates, table 4 confirms the high potency of AtSerpin1 to inhibit cathepsin-B protease activities from A. pisum aphid extracts (Table 5). 50% inhibition of cathepsin-B was scored with relatively low concentrations of 1.25 μM. For cathepsin-L activities the % of inhibition was somewhat lower yielding 39-42% at 1.25-10 μM.

TABLE 5
Inhibition of cysteine-like protease activities from
A. pisum extracts by the AtSerpin1.

| | % Inhibition | | | | | |
|---|---|---|---|---|---|---|
| | Cathepsin B | | | Cathepsin L | | |
| | 1.25 μM | 5 μM | 10 μM | 1.25 μM | 5 μM | 10 μM |
| AtSerpin1 | 50 ± 1 | 55 ± 5 | 55 ± 2 | 42 ± 3 | 42 ± 2 | 39 ± 4 |

### Example 8

### Inhibition of the Enzymes of the Sweetpotato Whitefly, Bemisia tabaci (Homoptera: Aleyrodidae)

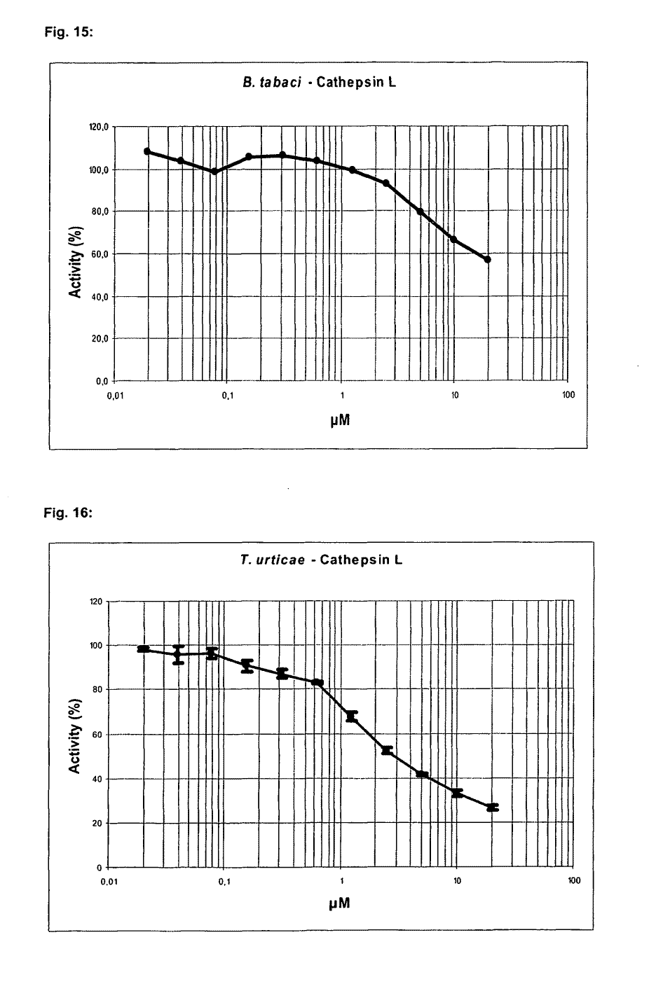

FIG. 15 demonstrates that the cysteine-like cathepsin-L activity is inhibited by the AtSerpin1 with the highest concentration tested (20 μM) 45% inhibition was scored.

### Example 9

### Spider Mites, Tetranychus urticae (Acari: Tetranychidae)

In spider mites, AtSerpin1 is active to inhibit cathepsin-L protease activities with 50% inhibition at about 2 μM (FIG. 16).

### Example 10

### Insect Inhibition on Transgenic Plants Overexpressing AtSerpin1

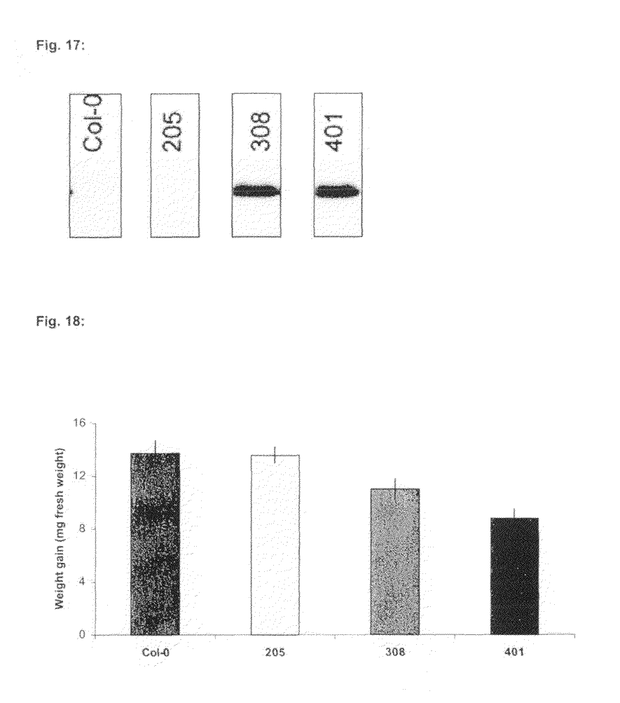

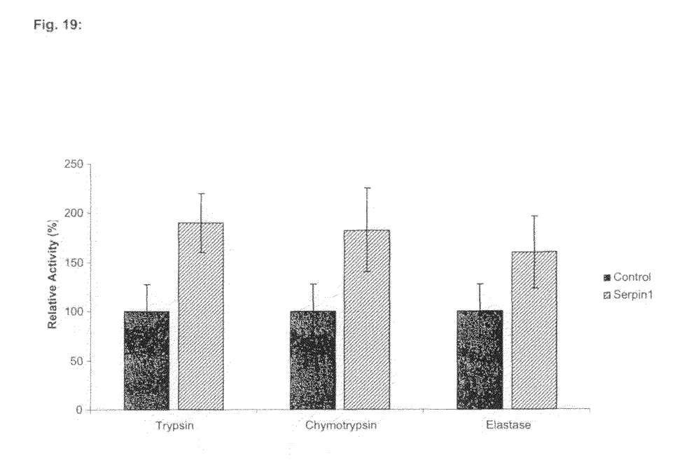

Arabidopsis overexpressing AtSerpin1 has been described by Vercammen of al. (2006). The overexpression was measured by Western blot in leaf tissue (FIG. 17). Two transgenic overexpressing plant lines (308 and 401) were used for further research and were infected with Spodoptera littoralis. Non transformed Arabidopsis thaliana Columbia-0 was used as positive control for the infection; the negative transformant 205 was also tested. A significant reduction in weight increase, compared to the control was noticed in the case of Spodoptera littoralis on the transgenic plants (FIG. 18). When AtSerpin1 is not expressed, as in the 205 line, no reduction in weight gain is noticed. Measurement of the relative activity of the protease digestive activities after feeding on the transgenic plants overexpressing AtSerpin1 showed that there is an increase in relative activity of these enzymes, as a reaction on the inhibitory activity of the protease inhibitor (FIG. 19).

In another experiment, transgenic overexpression plants are infected with Acyrthosiphon pisum. A significant reduction of aphid survival is seen on the transgenic plant, when compared with the untransformed control.

### REFERENCES

Alford D. V. (2000). Pest and disease management handbook. British Crop Protection Council. Blackwell Science. Oxford. 615 pp.
Brandt, A., Svendsen, I. and Hejgaard, J. (1990). A plant serpin gene. Structure, organisation and expression of the gene encoding barley protein Z. Eur. J. Biochem. 194, 499-505.
Dahl, S., Rasmussen, S. W. and Hejgaard, J. (1996). Heterologous expression of three plant serpins with distinct inhibitory specificities. J. Biol. Chem. 271, 25083-25088.
Dulmage, H. T. (1981) Production of bacteria for biological control of insects. In “Biological control in crop production”, Paparrizas, D. C. ed., pp 129-141.
Girard, C., Le Metayer, M., Zaccomer, B, Barlet, B., Barlet, E., Williams, I., Bonade-Bottino, M., Pham-Delegue, M. H. and Jouanin, L. (1998). Growth stimulation of beetle larvae reared on a transgenic oilseed rape expressing a cysteine proteinase inhibitor. J. Insect Physiol., 44, 263-270.
Goldberg, L. J. and Margalit, J. (1977). A bacterial spore demonstrating rapid larvicidal activity against Anopheles segentii, Uranotaenia unguiculata, Culex univittatus, Aedes aegypti and Culex pipiens. Mosquito News, 37, 355-358.
Hejgaard, J. (1982). Purification and properties of protein Z—a major albumin of barley endosperm. Physiol. Plant, 54, 174-182.
Hejgaard, J. (2001). Inhibitory serpins from rye grain with glutamine as P1 and P2 residues in the reactive center. FEBS lett. 488, 149-163.
Hejgaard, J. and Hauge, S. (2002) Serpins of oat (Avena sativa) grain with distinct reactive centres and inhibitory activity. Physiol. Plant 116, 155-163.
Haq, S. K., Atif, S. M. and Khan, R. H. (2004) Protein inhibitor genes in combat against insects, pest, and pathogens: natural and engineered phytoprotection. Arch. Biochem. Biophys. 431, 145-159.
Krieg, A., Huger, A. M. and Schnetter, W. (1987). Bacillus thuringiensis var san diego strain M-7 is identical to the formerly in Germany isolated strain BI 256-82, B. thuringiensis subsp. Tenebrionis, which is pathogenic to coleopteran insects. Z. Angew. Ent. 104, 417-425
Lungard, R. and Svensson, B. (1989). A 39 kD barley seed protein of the serpin superfamily inhibits alpha-chymotrypsin. Carlsberg Res. Commun. 54, 173-180.
Mathavan, S., Velpandi, A., Johnson, J. C. (1987). Sub toxic effects of Bacillus spaericus 1593 M on feeding growth and reproduction of Laccotrephes griseus (Hemiptera: Nepidae). Exp. Biol. 46, 149-153.
Østergaard, H., Rasmussen, S. K. Roberts, T. H. and Hejgaard, J. (2000). Inhibitory serpins from wheat grain with reactive centers resembling glutamine-rich repeats of prolamin storage proteins. Cloning and characterization of five major molecular forms. J. Biol. Chem. 275, 33272-33279.
Patston, P. A. (2000) Serpins and other serine protease inhibitors. Immunol. Today 21, 345-354.
Rabea, E., El Badawy, M., Rogge, T. M., Stevens, C. V., Höfte, M., Steurbaut, W. and Smagghe, G., (2005). Insecticidal and fungicidal activity of new synthesized chitosan derivatives. Pest Management Science 61, 951-960
Rasmussen, S. K. (1993) A gene coding for a new plant serpin. Biochim. Biophys. Acta 1172, 151-154.
Rasmussen, S. K., Dahl, S. W., Nørgard, A. And Hejgaard, J. (1996a). A recombinant wheat serpin with inhibitory activity. Plant Mol. Biol. 30, 673-677.
Rasmussen, S. K., Klausen, J., Heigaard, J., Svensson, B., and Svendsen, I. (1996b). Primary structure of the plant serpin BSZ7 having capacity of chymotrypsin inhibition. Biochim. Biophys. Acta, 1297, 127-130.
Roberts, T. H., Martina, S., Rasmussen, S. K. and Hejgaard, J. (2003). Differential gene expression for suicide substrate serine proteinase inhibitors (serpins) in vegetative and grain tissues of barley. J. Exp. Bot. 54, 2251-2263.
Rosenkrands, I. Heygaard, J., Rasmussen, S. K. and Bjørn, S. E. (1994). Serpins from wheat grain, FEBS lett. 343, 75-80.
Smagghe, G., Decombel, L., Carton, B., Voigt, B., Adam, G. and Tirry, L. (2002). Action of brassinosteroids in the cotton leafworm Spodoptera littoralis. Insect Biochemistry and Molecular Biology 32, 199-204.
Tabashnik, B. E., Roush, R. T., Earle, E. D. (2000). Resistance to Bt toxins. Science 287, 42-42.
Van Gent, D., Sharp, P., Morgan, K. And Kalsheker, N. (2003). Serpins: structure, function and molecular evolution. Int. J. Biochem. Cell. Biol. 35, 1536-1547.
Vercammen, D., van de Cotte, B., De Jaeger, G., Eeckhout, D., Casteels, P., Vandepoele, K., Vandenberghe, I., Van Beeumen, J., Inzé, D. And Van Breusegem, F. (2004). Type II metacaspases Atmc4 and Atmc9 pf Arabidopsis thaliana cleave substrates after arginine and lysine. J. Biol. Chem. 279, 45329-45336.
Vercammen, D., Belenghi, B., van de Cotte, B., Beunens, T., Gavigan, J. A., De Rycke, R., Brackenier, A., Inzé, D., Harris, J. L. and Van Breusegem, F. (2006). Serpin 1 of Arabidopsis thaliana is a suicide inhibitor for metacaspase 9. J. Mol. Biol.
Yoo, B. C., Aoki, K., Xiang, Y., Campbell, L. R., Hull, R. J., Xoconostle-Cazares, B., Monzer, J., Lee, J. Y., Ullman, D. E. and Lucas, W. J. (2000). Characterization of Cucurbita maxima Phloem Serpin-1 (CmPS-1). A developmentally regulated elastase inhibitor. J. Biol. Chem. 275, 35122-35128.

1. A method of limiting insect and/or mite provoked damage in a plant, the method comprising:
utilizing a recombinant serpin, the recombinant serpin comprising a reactive center loop with a leucine/arginine or aspartic acid/arginine sequence, to limit insect and/or mite provoked damage in the plant.

2. The method according to claim 1, wherein said recombinant serpin is selected of the group consisting of Arabidopsis thaliana serpin At1g47710 (SEQ ID NO:1), Barley serpin BSZx, Barley serpin BSZ7, Wheat serpin WSZ2b, Cucumis sativus serpin gi|58416137, Oryza sativa serpin gi|37700305, Citrus×paradise serpin gi|26224736, Solanum tuberosum serpin gi|62950609, Lycopersicon esculentum serpin gi|14685955, Nicotiana tabacum serpin gi|52837819, Brassica rapa serpin gi|54416864, Vitis vinifera serpin gi|33401535, Antirrhinus majus serpin gi|51113970, Triphysaria versicolor serpin gi|68033793, Helianthus paradoxus serpin gi|33123072, Gossypium arboretum serpin gi|13245345, Populus nigra serpin gi|60218046, and Brassica napus (SEQ ID NO: 2).

3. The method according to claim 2, wherein said recombinant serpin comprises SEQ ID NO: 1 (At1g47710).

4. The method according to claim 2, wherein said recombinant serpin comprises SEQ ID NO: 2 (Brassica napus).

5. The method according to claim 1, wherein said insect and/or mite provoked damage is caused by a chewing insect.

6. The method according to claim 5, wherein said insect or mite belongs to an order selected from the group consisting of Lepidoptera, Coleoptera, Homoptera and Acari.

7. The method according to claim 6, wherein said insect or mite is selected from the group consisting of Spodoptera spp, Sesamia spp., Ostrinia spp., Leprinotarsa spp., Tribolium spp., Acyrthosiphon spp., Bemisia spp. and Tetranychus spp.

8. The method according to claim 1, wherein said serpin is applied by spraying.

9. The method according to claim 1, wherein said serpin is overexpressed in a plant.

10. A method of limiting insect and/or mite provoked damage in a transgenic plant, the method comprising:
expressing a recombinant serpin therein, said serpin comprising a reactive center loop with at least one arginine residue, for limiting insect and/or mite provoked damage in the plant.

11. A method of limiting insect and/or mite induced damage in a plant, the method comprising: overexpressing a serpin comprising a reactive center loop with a leucine/arginine or aspartic acid/arginine sequence in the plant, so as to limit insect and/or mite induced damage therein.
